(19) United States
(12) Patent Application Publication
(10) Pub. No.: US 2011/0188872 A1
(43) Pub. Date: Aug. 4, 2011

(54) FIXING DEVICE AND IMAGE FORMING APPARATUS

(76) Inventors: Takashi NARA, Tokyo (JP); Satoshi Ogata, Tokyo (JP); Tadashi Matsudaira, Tokyo (JP); Youbao Peng, Tokyo (JP); Akihiro Hayashi, Okazaki-shi (JP); Eiji Nishikawa, Tokyo (JP)

(21) Appl. No.: 13/011,468

(22) Filed: Jan. 21, 2011

(30) Foreign Application Priority Data
Jan. 29, 2010 (JP) 2010-017539

(51) Int. Cl. G03G 15/20

(52) U.S. Cl. 399/67

(57) ABSTRACT

Disclosed is a fixing device including a fixing belt to fix a toner image formed on a paper onto the paper, a driving unit to make the fixing belt reciprocate in a direction perpendicular to a feeding direction of the paper when fixing the toner image onto the paper and a detecting unit to detect a position of the fixing belt in the perpendicular direction, and a control target value of the fixing belt is changed in accordance with the position of the fixing belt in the perpendicular direction detected by the detecting unit, and the fixing belt is made to reciprocate by the driving unit based on the changed control target value.

### BACKGROUND OF THE INVENTION

1. Field of the Invention

The present invention relates to a fixing device and an image forming apparatus.

2. Description of Related Art

There is conventionally known a fixing device for fixing a toner image which is transferred onto a sheet of paper. In the fixing device, the toner image is heated to be fixed on a paper while the paper is nipped and conveyed by a fixing-rotation member.

When the toner image is to be fixed, since the fixing-rotation member nips the paper, the fixing-rotation member and the paper come into contact with each other. Therefore, it is known that a surface of the fixing-rotation member is scarred (scars are generated) by edges of the paper, and image failure occurs by the scars.

As a technique for inhibiting a surface of the fixing-rotation member from being scarred by the paper edges, there is known a technique in which a spring is made to be in contact with one end of the fixing-rotation member (transferring-fixing roller), a pressing body which is connected to a solenoid is made to be in contact with the other end, and the transferring-fixing roller is reciprocated based on information on the total number of papers to be fed (see Japanese Patent Application Laid-open No. 2007-148336).

However, according to the technique of Japanese Patent Application Laid-open No. 2007-148336 the transferring-fixing roller is moved by using the solenoid as a driving unit and a moving amount of the transferring-fixing roller can be changed only in several stages. Therefore, there is a problem that scars are generated at predetermined positions of the transferring-fixing roller by paper edges

According to this configuration in which the transferring-fixing roller is moved, there is a problem that a large driving unit is required to move the transferring-fixing roller and this is not practical in terms of cost and space.

Therefore, it is a main object of the present invention to inhibit a surface of a fixing belt from being scarred by paper edges without requiring a large driving unit and to reduce occurrence of image failure.

### SUMMARY OF THE INVENTION

To achieve at least the one object, a fixing device which reflects one aspect of the present invention includes a fixing belt to fix a toner image formed on a paper onto the paper, a driving unit to make the fixing belt reciprocate in a direction perpendicular to a feeding direction of the paper when fixing the toner image onto the paper and a detecting unit to detect a position of the fixing belt in the perpendicular direction, and a control target value of the fixing belt is changed in accordance with the position of the fixing belt in the perpendicular direction detected by the detecting unit, and the fixing belt is made to reciprocate by the driving unit based on the changed control target value.

To achieve at least the one object, an image forming apparatus which reflects one aspect of the present invention includes a fixing belt to fix a toner image formed on a paper onto the paper, a driving unit to make the fixing belt reciprocate in a direction perpendicular to a feeding direction of the paper when fixing the toner image onto the paper, a detecting unit to detect a position of the fixing belt in the perpendicular direction and a second control unit to change a control target value of the fixing belt in accordance with the position of the fixing belt in the perpendicular direction detected by the detecting unit and to control the driving unit so as to make the fixing belt reciprocate by the driving unit based on the changed control target value.

### BRIEF DESCRIPTION OF THE DRAWINGS

The present invention will become more fully understood from the detailed description given hereby and the appended drawings, and thus are not intended as a definition of the limits of the present invention, and wherein:

FIG. 1 is a diagram showing a functional configuration of an image forming apparatus according to the embodiment;

FIG. 2 is a control block diagram of the image forming apparatus;

FIG. 3 is a diagram showing scars generated on a fixing belt;

FIG. 4 is a schematic diagram showing a configuration of a fixing unit;

FIG. 5 is a perspective view of a configuration of a steering angle changing unit;

FIG. 6 is a diagram showing a relation between a fixing belt and a shaft angle of a steering roller as viewed from a direction V in FIG. 4;

FIG. 7 is a diagram showing a waveform of steering control target value;

FIG. 8 is a diagram showing a waveform of steering control target value;

FIG. 9 is a flowchart showing the first processing;

FIG. 10 is a flowchart showing the second processing;

FIG. 11 is a flowchart showing the third processing; and

FIG. 12 is a flowchart showing the fourth processing;

### PREFERRED EMBODIMENT OF THE PRESENT INVENTION

Hereinafter, a preferred embodiment of the present invention will be described in detail with reference to the accompanying drawings. The scope of the invention is not limited to the illustrated examples.

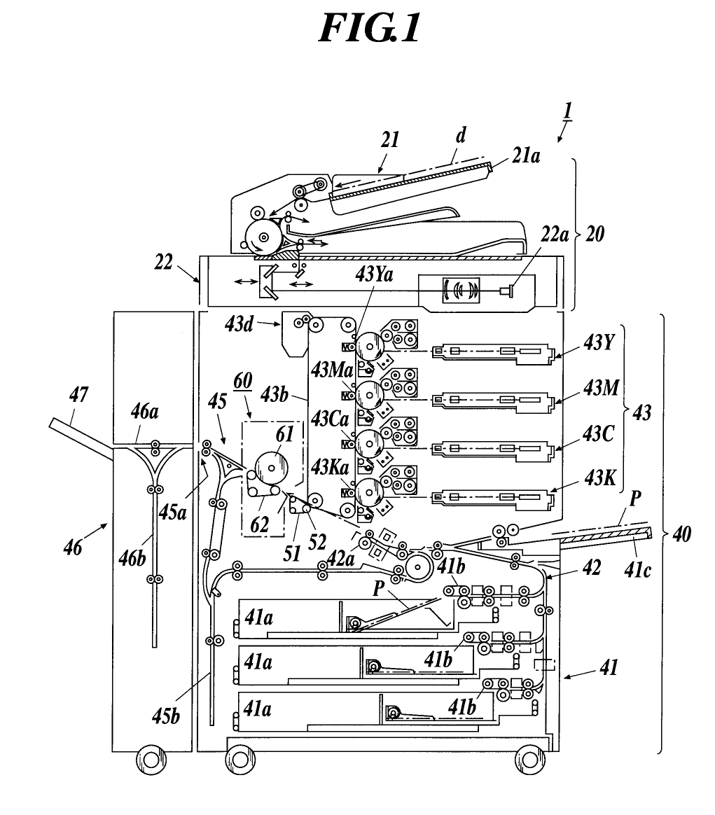

First, a schematic sectional view of a configuration of an image forming apparatus 1 will be described with reference to FIG. 1. The image forming apparatus 1 has a copy function for reading an image from a document, forming the read image on a sheet of paper P and outputting the paper P, a print function for receiving a job which includes page data including image data, an image forming condition of each image data and the like from an external apparatus, forming an image on a paper P based on the received job and outputting the paper P, and the like. As shown in FIG. 1, the image forming apparatus 1 includes an image reading unit 20, a print unit 40 and the like.

The image reading unit 20 includes an automatic document feeder 21 called ADF (Automatic Document Feeder) and a reading unit 22. A document d placed on a document tray 21a of the automatic document feeder 21 is conveyed to a contact glass which is a reading location, an image of one side or images of both sides of the document d are read by an optical system, and the images of the document d are read by a CCD (Charge Coupled Device) 22a. Here, images are not limited to image data such as graphics and photographs, and includes text data such as letters and symbols.

The image (analogue image signal) which was read by the image reading unit 20 is output to the after-mentioned control unit 90, various types of image processing such as A/D conversion are carried out in the control unit 90 and thereafter, the image is output to the print unit 40.

The print unit 40 carries out an electro-photographic image forming process based on the inputted print data. The print unit 40 includes a paper feeder 41, a conveying unit 42, an image forming unit 43, a fixing unit 60, a carry-out unit 45 and a carry-out standby unit 46.

The paper feeder 41 includes a plurality of paper feed trays 41a, a plurality of paper feed units 41b, and a manual paper feed tray 41c. Papers P such as standard papers, special papers, insertion papers and the like which are recognized based on the basis weight, size and the like are set in the respective paper feed trays 41a according to the type of paper which is set in advance for each tray. The papers P are conveyed toward the conveying unit 42 from the top paper P one by one. The manual paper feed tray 41c is a paper feed tray on which various kinds of papers P can be placed in accordance with the need of a user, and the manual paper feed tray 41c conveys the placed papers P toward the conveying unit 42 from the top paper P one by one by the paper feed roller.

The conveying unit 42 conveys a paper P conveyed from the paper feed trays 41a or the manual paper feed tray 41c to a secondary transfer belt 51 via a plurality of intermediate rollers and a resist roller 42a. The resist roller 42a functions as a first standby unit which temporarily keeps the paper P to be conveyed to the secondary transfer belt 51 to be on stand-by. Further, the secondary transfer belt 51 functions as a secondary transfer unit which carries out a secondary transfer of a toner image which is on an intermediate transfer body (intermediate transfer belt 43b) onto the paper P.

Moreover, the conveying unit 42 conveys a paper P to which the image forming process for the image on one side is finished to a both-side conveying path by a conveying path switching plate, and again conveys the paper P to the secondary transfer belt 51 via the intermediate rollers and the resist roller 42a. By the secondary transfer belt 51, the toner image which was primary transferred onto the after-mentioned intermediate transfer belt 43b is secondary transferred onto the paper P.

The image forming unit 43 includes image forming units 43Y, 43M, 43C and 43K each of which is capable of charging toner of different color when an image of four colors (yellow (Y), magenta (M), cyan (C) and black (K)) is to be formed, for example. The image forming unit 43 further includes the intermediate transfer belt 43b and a cleaning unit 43d.

For example, the image forming unit 43Y includes a charging device, an exposing device and a developing device which are disposed around a photosensitive drum, a primary transfer roller 43Ya which functions as a primary transfer unit for primary transferring a toner image which is generated by an electrostatic latent image being developed based on image data onto the intermediate transfer belt 43b and a cleaning apparatus, and the image forming unit 43Y forms an image of yellow (Y).

In particular, light corresponding to image data of yellow (Y) is irradiated to the photosensitive drum which is charged by the charging device from the exposing device to form an electrostatic latent image. Then, the developing device adheres the charged toner of yellow (Y) onto the surface of the photosensitive drum on which the electrostatic latent image is formed to develop the electrostatic latent image. The photosensitive drum on which toner is adhered by the developing device is rotated at a constant speed to a transfer position where the primary transfer roller 43Ya is disposed, and toner is primary transferred onto the intermediate transfer belt 43b. After the toner is primary transferred onto the intermediate transfer belt 43b, the cleaning device removes the residual electric charge and the residual toner from the surface of the photosensitive drum.

The image forming units 43M, 43C and 43K have similar configuration as that of the image forming unit 43Y, and respectively form images of magenta (M), cyan (C) and black (K).

The intermediate transfer belt 43b is a semiconductive endless belt which is hung by and rotatably supported by a plurality of rollers, and is driven and moved as the rollers such as a drive roller rotate.

The intermediate transfer belt 43b is pressed onto the respective photosensitive drums by the primary transfer rollers 43Ya, 43Ma, 43Ca and 43Ka of the image forming units 43Y, 43M, 43C and 43K. In such way, the toners developed on surfaces of the photosensitive drums are primary transferred onto the intermediate transfer belt 43b at transfer positions of the primary transfer rollers 43Ya, 43Ma, 43Ca and 43Ka, respectively, and the toners of yellow, magenta, cyan and black are sequentially secondary transferred so as to be superimposed on the paper P at the transfer position of a secondary transfer roller 52. The secondary transfer roller 52 functions as a secondary transfer unit which secondary transfers the toner images which are primary transferred onto the intermediate transfer belt 43b onto the paper P.

Then, the intermediate transfer belt 43b secondary transfers the toner image onto the paper P by the secondary transfer roller 52 and thereafter, the paper P is curved and electrostatically separated from the intermediate transfer belt 43b and the residual toner is removed by the cleaning unit 43d.

The fixing unit 60 includes a heater roller 61 having a heater lamp 61a and a fixing belt 62. The heater roller 61 and the fixing belt 62 fix the toner image formed on the paper P.

The carry-out unit 45 includes a plurality of paper-ejecting rollers, a carry-out port 45a and a paper-ejecting surface switching path 45b, and the paper P on which the toner image is fixed is nipped by the paper-ejecting rollers and is conveyed to the carry-out standby unit 46 from the carry-out port 45a by the conveying path switching plate. Further, the carry-out unit 45 conveys the paper P to the paper-ejecting surface switching path 45b which functions as a paper-ejecting side switching unit for switching sides of the paper to be ejected to the carry-out standby unit 46 and thereafter, the paper P is conveyed to the carry-out standby unit 46 from the carry-out port 45a.

The carry-out standby unit 46 is provided between a secondary transfer roller 52 and a paper-ejecting tray 47 and includes a plurality of paper-ejecting rollers, a first carry-out path 46a and a second carry-out path 46b. Further, the carry-out standby unit 46 conveys the paper P which is conveyed from the carry-out port 45a to the first carry-out path 46a or the second carry-out path 46b and thereafter, ejects the paper to the paper-ejecting tray 47.

The first carry-out path 46a is a path for ejecting the paper P which is conveyed from the carry-out port 45a in the same side as the side of the paper when conveyed from the carry-out port 45a to the paper-ejecting tray 47. The second carry-out path 46b functions as a second standby unit which temporarily keeps the paper P which is conveyed from the carry-out port 45a to be on stand-by, and the second carry-out path 46b is a path for ejecting the paper to the paper-ejecting tray 47 at a predetermined timing and is a path for ejecting the paper to the paper-ejecting tray 47 in a side opposite from the side of the paper when the paper is conveyed to the paper-ejecting tray 47 via the first carry-out path 46a.

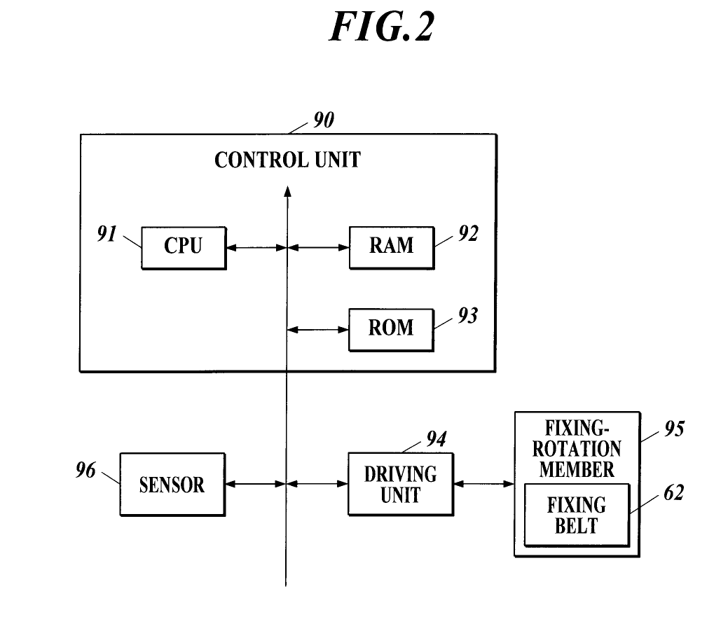

Next, a control block diagram of the image forming apparatus 1 will be described with reference to FIG. 2.

As shown in FIG. 2, the image forming apparatus 1 includes the control unit 90 as a second control unit, a driving unit 94, a fixing-rotation member 95 and a sensor 96 as a detector.

The control unit 90 includes a CPU (Central Processing Unit) 91, a RAM (Random Access Memory) 92 and a ROM (Read Only Memory) 93.

The CPU 91 reads a system program and a designated program among various types of application programs stored in the ROM 93 and expands the programs in the RAM 92. Further, the CPU 91 executes various types of processes in cooperation with the programs expanded in the RAM 92 and performs centralized control of various parts of the image forming apparatus 1.

The RAM 92 is a volatile memory, and the RAM 92 includes a work area in which various types of programs to be executed by the CPU 91 and data related to the various types of programs are stored and the RAM 92 temporarily stores information thereof. The ROM 93 stores various types of programs to be executed by the CPU 91.

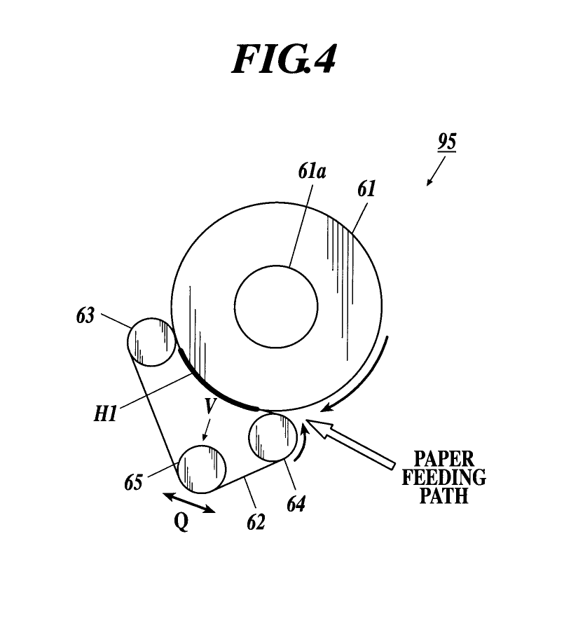

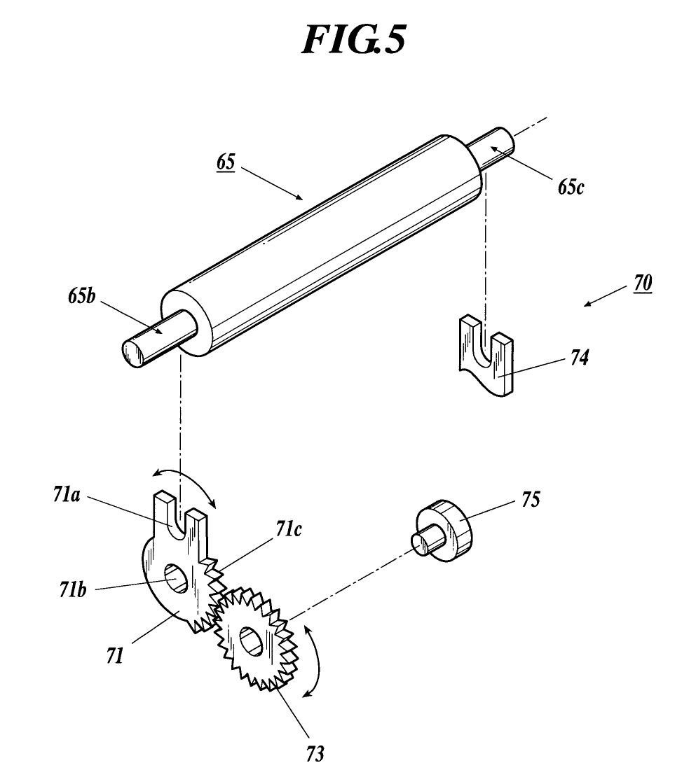

The driving unit 94 includes a motor and a driving mechanism (for example, angle changing unit 70: see FIG. 5) for driving the fixing-rotation member 95. The fixing-rotation member 95 is a rotation member for fixing a toner image onto a paper P, and includes a fixing belt 62 and the like. In particular, in addition to the fixing belt 62, the fixing-rotation member 95 also includes a heater roller 61, a driving roller 63, a follower roller 64 and a steering roller 65 (see FIG. 4).

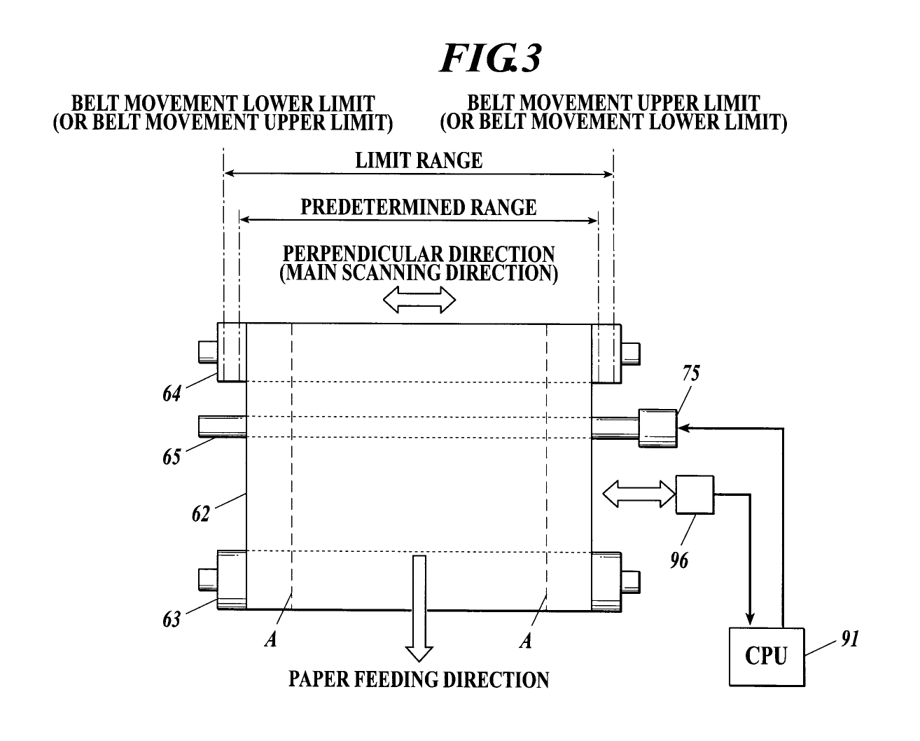

The sensor 96 detects a position of the fixing belt 62 in the perpendicular direction (main scanning direction; see FIG. 3). In particular, the sensor 96 detects the position of the fixing belt 62 in the perpendicular direction by detecting the movement of a shaft (contactor) which comes into contact with an end of the fixing belt 62 by light.

Next, scars to be generated on the fixing belt 62 will be described with reference to FIG. 3. FIG. 3 shows the fixing belt 62, the driving roller 63, the follower roller 64, the steering roller 65, a stepping motor 75, the CPU 91 and the sensor 96. Hereinafter, the parts similar to those shown in FIG. 2 are designated with the same symbols, and the detailed descriptions are cited from the above and the different portions will mainly be described.

The fixing belt 62 is a ring-like belt member, and the driving roller 63, the follower roller 64 and the steering roller 65 are disposed inside the ring. The fixing belt 62 is stretched by cooperation of the driving roller 63, the follower roller 64 and the steering roller 65. Further, the driving roller 63 and the follower roller 64 are rotated by a command from the driving unit 94 to drive the fixing belt 62.

The steering roller 65 reciprocates the fixing belt 62 in the perpendicular direction (a direction perpendicular to the paper-feeding direction of a paper P: main scanning direction) so that the fixing belt 62 does not come off from the driving roller 63 and the follower roller 64. The stepping motor 75 is a motor for driving the steering roller 65. Here, when the sensor 96 detects that the fixing belt 62 reaches predetermined positions (the after-mentioned limit positions), a control is performed to return the fixing belt 62 in a direction opposite from the coming-off direction, which is the direction in which the fixing belt 62 may come off from the rollers, so that the fixing belt 62 does not come off from the driving roller 63 and the follower roller 64. This control is called steering control.

Here, a paper P is fed in the paper-feeding direction shown in FIG. 3. At this time, when the paper P passes through the same position on the fixing belt 62, scars are generated on the fixing belt 62 by paper edges. Lines A shown in FIG. 3 schematically show the scars generated on the fixing belt 62. When the scars are generated on the fixing belt 62, image failure due to the scars occurs.

Here, a belt movement upper limit and a belt movement lower limit shown in FIG. 3 indicate limit positions (upper and lower limit positions) that define limits of a range of reciprocating movement of the fixing belt 62. Further, the limit range shows a range where the fixing belt 62 can reciprocate, and the limit range corresponds to a range from the belt movement upper limit to the belt movement lower limit. Furthermore, a predetermined range shows a range narrower than the limit range by a predetermined distance.

Next, a configuration of the fixing unit 60 will be described with reference to FIG. 4. As shown in FIG. 4, the fixing unit 60 includes the heater roller 61, the fixing belt 62, the driving roller 63, the follower roller 64 and the steering roller 65. The parts similar to those shown in FIGS. 2 and 3 are designated with the same symbols, and the detailed descriptions are cited from the above and the different portions will mainly be described.

The heater roller 61 and the fixing belt 62 are pressed onto each other to form a fixing nip H1, and a toner image is fixed onto a paper P which passes through the fixing nip H1.

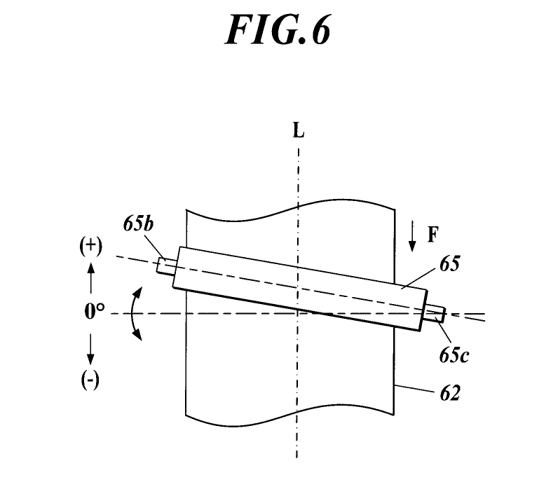

Next, a position control of the fixing belt 62 will be described with reference to FIGS. 5 and 6.

FIG. 5 is a perspective view of a configuration of a steering roller angle changing unit 70. The steering roller 65 is disposed so that the disposition angle of the steering roller 65 with respect to an operating direction of the fixing belt 62 can be changed by the steering roller angle changing unit 70. The steering roller angle changing unit 70 includes a rotating member 71, a rotating gear 73, a supporting unit 74 and the stepping motor 75.

The steering roller 65 has a shaft portion, and one end 65b of the shaft portion is supported by a U-groove 71a of the rotating member 71. The rotating member 71 is rotatably supported by the shaft portion 71b in which the axis line is along a width direction (perpendicular direction) of the fixing belt 62, the shaft portion 71b being the shaft center. The rotating member 71 has a gear portion 71c which meshes with the rotating gear 73.

The rotating gear 73 is connected to the stepping motor 75, and the rotating angle of the rotating gear 73 is changed by driving of the stepping motor 75. The rotating member 71 is rotated and is supported at a rotating angle corresponding to the rotating angle of the rotating gear 73, and thereby the rotating member 71 rotates and supports the one end 65b of the steering roller 65.

The other end 65c of the shaft portion of the steering roller 65 is supported by the supporting unit 74 provided at a frame in the image forming apparatus 1. The supporting unit 74 rotatably supports the steering roller 65 and supports the steering roller 65 in a state where on end of the steering roller 65 can be rotated by the rotating member 71. In such way, the one end 65b side of the steering roller 65 is provided so as to rotate in the directions indicated by the two-directional arrow Q shown in FIG. 4, and the disposition angle of the fixing belt 62 with respect to the operating direction (the same direction as the paper-feeding direction) can be changed.

FIG. 6 shows a diagram for explaining a relation between a shaft angle of the steering roller 65 and the fixing belt 62 as viewed from a direction V in FIG. 4. The dashed line L in FIG. 6 indicates the position of the fixing belt 62 in its width direction where the heater roller 61 and the fixing belt 62 come into contact by pressure most preferably.

When the one end 65b of the steering roller 65 turns more in the side of the operating direction F (in minus direction in FIG. 6) of the fixing belt 62 comparing to the other end 65c, the fixing belt 62 is lead (moved) toward the other end 65c side of the steering roller 65. On the other hand, when the one end 65b of the steering roller 65 turns more in the side opposite from the operating direction F (in plus direction in FIG. 6) of the fixing belt 62 comparing to the other end 65c, the fixing belt 62 is lead (moved) toward the one end 65b side of the steering roller 65.

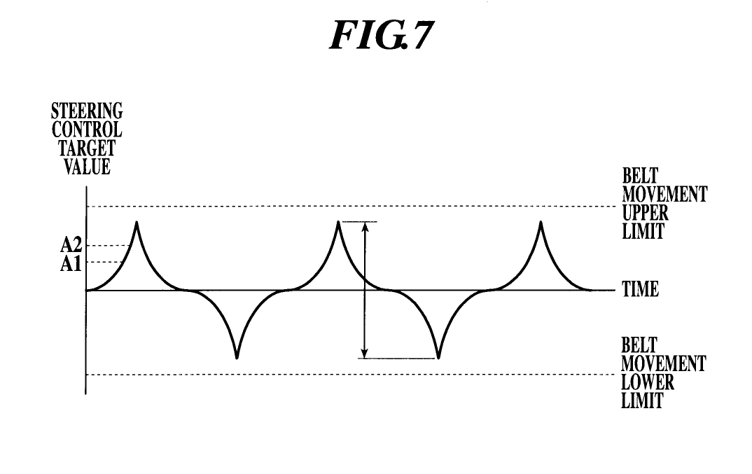

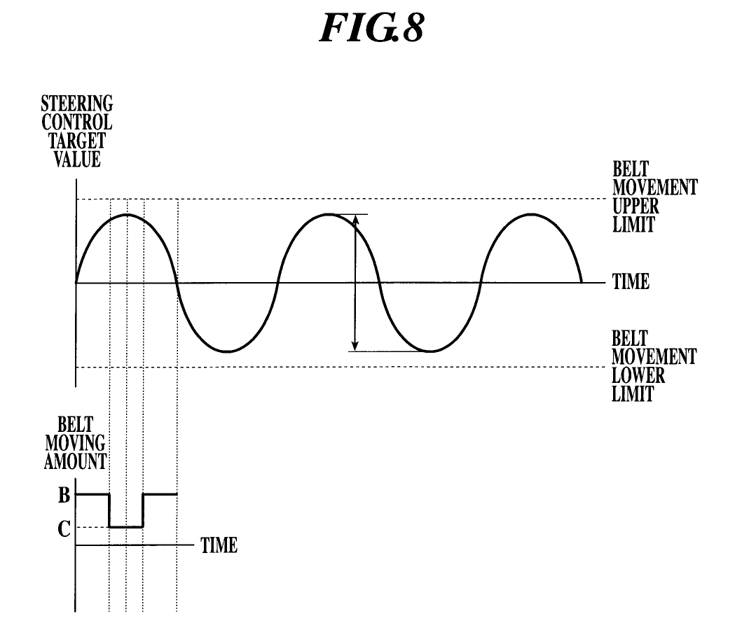

Next, a control for reciprocating the fixing belt 62 will be described with reference to FIGS. 7 and 8. In each of FIGS. 7 and 8, a vertical axis indicates a steering control target value (control target value) and a lateral axis indicates time. The steering control target value is a control command value for reciprocating the fixing belt 62 in the perpendicular direction. In particular, the control target value is a control command value which is outputted from the CPU 91 to the stepping motor 75 for moving the fixing belt 62 to predetermined target positions in the perpendicular direction. When the steering control target value is outputted form the CPU 91 to the stepping motor 75, the stepping motor 75 is driven based on the steering control target value. When the stepping motor 75 is driven, the one end 65b of the steering roller 65 is turned and the fixing belt 62 reciprocates in the perpendicular direction. That is, the fixing belt 62 reciprocates in the perpendicular direction based on the steering control target value.

Here, a belt movement upper limit and a belt movement lower limit correspond to the belt movement upper limit and the belt movement lower limit shown in FIG. 3.

FIG. 7 shows a waveform when the steering control target value is changed so that a moving amount of the fixing belt 62 per predetermined time increases (moving speed of the fixing belt 62 increases) as the position of the fixing belt 62 approaches the belt movement upper limit or the belt movement lower limit.

the two-directional arrow in FIG. 7 show amplitude of the waveform. The amplitude of the waveform corresponds to a reciprocating range (moving range) of the fixing belt 62. The moving range of the fixing belt 62 is determined based on paper size information. The waveform shown in FIG. 7 is one example when the moving range of the fixing belt 62 is determined based on the paper size information. The moving range of the fixing belt 62 is allowed to be set within a range (limit range) from the belt movement upper limit to the belt movement lower limit. Therefore, the maximum amplitude of the waveform shown in FIG. 7 is the range from the belt movement upper limit to the belt movement lower limit.

As shown in FIG. 7, as the steering control target value approaches the belt movement upper limit or the belt movement lower limit, the inclination of the waveform becomes steep. That is, as the position of the fixing belt 62 approaches the belt movement upper limit or the belt movement lower limit, the moving amount of the fixing belt 62 per predetermined time is increased (moving speed of the fixing belt 62 is increased). For example, it is assumed that the position of the fixing belt 62 in the perpendicular direction is detected by the sensor 96, and that the steering control target value at the detected position is A1. In such case, the steering control value after predetermined time is elapsed is different from the control target value A1, and is changed to the steering control target value A2 in which the moving amount per predetermined time is increased comparing to that of the steering control target value A1. Then, the fixing belt 62 is moved based on the steering control target value A2. In such way, the passing positions of the edge portions (paper edges) of the papers P on the fixing belt 62 can be dispersed, and the occurrence of image failure can be reduced. Further, by shortening the time during which the fixing belt 62 is located at the belt movement upper limit or the belt movement lower limit, it is possible to inhibit the fixing belt 62 from coming off and the scars to be generated at the end portions of the fixing belt 62 can be reduced.

FIG. 8 shows a waveform when the moving amount of the fixing belt 62 is determined based on whether the position of the fixing belt 62 is within the limit range and outside the predetermined range or not and when the steering control target value is changed so that the moving amount of the fixing belt 62 be the determined moving amount. The two-directional arrow in FIG. 8 shows a moving range of the fixing belt 62 which is determined based on paper size information.

When the position of the fixing belt 62 is within the predetermined range, the steering control target value is changed so that the moving amount of the fixing belt 62 be the moving amount B (corresponding to the belt moving amount B in FIG. 8). When the position of the fixing belt 62 is within the limit range and outside the predetermined range, the steering control target value is changed so that the moving amount of the fixing belt 62 be the moving amount C (corresponding to the belt moving amount C in FIG. 8). At this time, the moving amount C shows a moving amount smaller than the moving amount B. Further, the moving amount C shows a moving amount in which the fixing belt 62 does not reach the belt movement upper limit or the belt movement lower limit (limit positions). In such way, when the position of the fixing belt 62 is outside the predetermined range, because the steering control target value is changed so as to be the moving amount C, the fixing belt 62 does not reach the belt movement upper limit or the belt movement lower limit. Here, the moving amount B and the moving amount C in FIG. 8 are shown in absolute values.

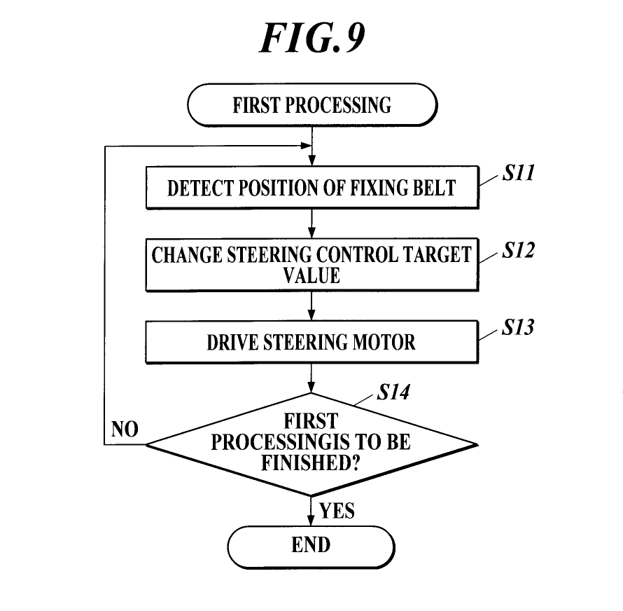

Next, the first processing will be described with reference to FIG. 9. In the first processing, the steering control target value is changed so that the moving speed of the fixing belt 62 increases as the position of the fixing belt 62 approaches the belt movement upper limit or the belt movement lower limit.

The belt movement upper limit and the belt movement lower limit (hereinafter, upper and lower limit values) are stored in a storage device in the image forming apparatus 1 in advance.

For example, detection of a flag indicating that an image forming operation is started by the CPU 91 being a trigger, the first processing is executed by the CPU 91 cooperating with the first program which was read from the ROM 93 and expanded in the RAM 92.

First, the sensor 96 detects the position of the fixing belt 62 (position in the perpendicular direction) (step S11). Then, a target value of the steering control is changed according to the detected position of the fixing belt 62 (step S12). In particular, the steering control target value at the detected position of the fixing belt 62 is obtained first. Then, the steering control target value is changed to a value which is different from the obtained steering control target value. At this time, the steering control target value is changed so that the moving speed of the fixing belt 62 increases as the position of the fixing belt 62 approaches the upper and lower limit values.

After step S12 is executed, the steering motor (stepping motor 75) is driven based on the set steering control target value (step S13). In such way, the fixing belt 62 is reciprocated in the perpendicular direction. After step S13 is executed, whether the first processing is to be finished or not is determined (step S14). In particular, this step is determined based on whether the CPU 91 has detected the flag indicating the completion of the image forming operation or not.

When it is determined in step S14 that the first processing is not to be finished (step S14; NO), the process moves to step S11. When it is determined in step S14 that the first processing is to be finished (step S14; YES), the first processing is completed.

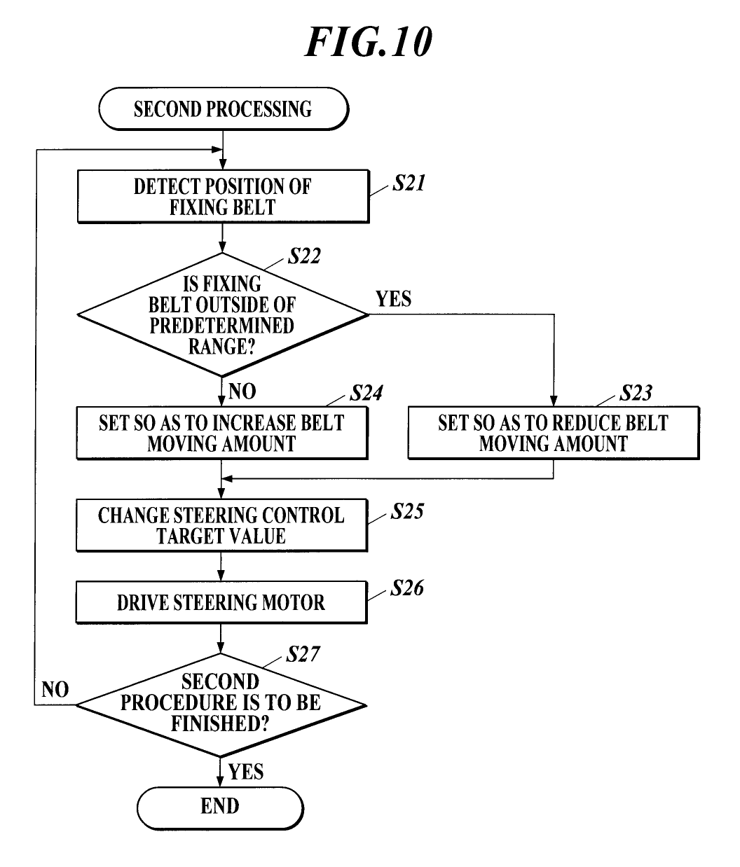

Next, the second processing will be described with reference to FIG. 10. In the second processing, when the position of the fixing belt 62 is within the limit range and outside the predetermined range, the steering control target value is changed so that the belt moving amount is reduced (moving amount C).

It is assumed that the upper and lower limit values and the predetermined range are stored in the storage device and that the moving amount B and the moving amount C (see FIG. 8) are stored in the storage apparatus as the moving amounts of the fixing belt.

For example, detection of a flag indicating that an image forming operation is started by the CPU 91 being a trigger, the second processing is executed by the CPU 91 cooperating with the second program which was read from the ROM 93 and expanded in the RAM 92.

Step S21 is similar to step S11 in the first processing. After step S21 is executed, it is determined whether the position of the fixing belt 62 is outside the predetermined range or not (step S22). In particular, the predetermined range is read from the storage device, and it is determined whether the position of the fixing belt 62 is within the limit range and outside the predetermined range or not based on the read predetermined range and the position of the fixing belt 62 detected in step S21.

When it is determined in step S22 that the position of the fixing belt 62 is outside the predetermined range (step S22; YES), the belt moving amount is set to a small value (step S23). In particular, the moving amount C is read from the storage device, and the read moving amount C is set as the moving amount of the fixing belt 62. After step S23 is executed, the process moves to the after-mentioned step S25.

When it is determined in step S22 that the position of the fixing belt 62 is not outside the predetermined range (step S22; NO), the moving amount of the fixing belt 62 is set to a large value (step S24). In particular, the moving amount B is read from the storage device, and the read moving amount B is set as the moving amount of the fixing belt 62.

After step S24 is executed, the steering control target value is set (step S25). In particular, the steering control target value is set so as to be the moving amount set in step S23 or S24. For example, when the process is moved to step S25 via step S23, the steering control target value is set so that the fixing belt 62 moves from the current position by the moving amount C. When the process is moved to step S25 via step S24, the steering control target value is set so that the fixing belt 62 moves from the current position by the moving amount B.

Steps S26 and S27 are similar to steps S13 and S14 of the first processing.

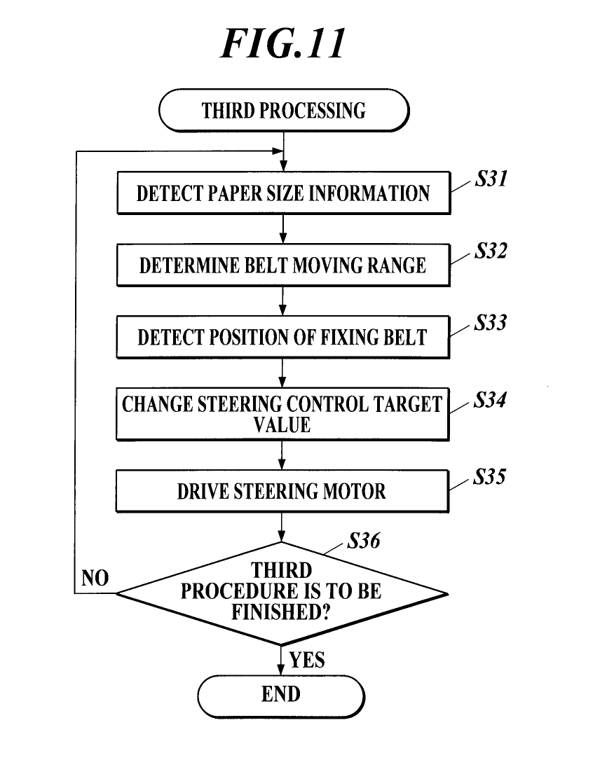

Next, the third processing will be described with reference to FIG. 11. In the third processing, the steering control target value is changed so that the moving speed of the fixing belt 62 is increased as the position of the fixing belt 62 approaches the upper or lower limit position and so that the position of the fixing belt 62 falls within the moving range determined based on the paper size information.

It is assumed that the moving range of the fixing belt 62 corresponding to the paper size is stored in the storage apparatus in advance. At this time, as for the moving range of the fixing belt 62, it is assumed that the wider moving range is stored as the paper size becomes larger. For example, the moving range of the fixing belt 62 when the paper size is A3 size is wider than the moving range of the fixing belt 62 when the paper size is A4 size.

For example, detection of a flag indicating that an image forming operation is to be executed by the CPU 91 being a trigger, the third processing is executed by the CPU 91 cooperating with the third program which was read from the ROM 93 and expanded in the RAM 92.

First, paper size information is detected (step S31). Then, a belt moving range is determined based on the paper size information (step S32). In particular, a moving range of the fixing belt 62 corresponding to the detected paper size information is read from the storage device, and the read information is determined as the moving range of the fixing belt 62.

Step S33 is similar to step S11 in the first processing. After step S33 is executed, a steering control target value is set (step S34). In particular, a steering control target value at the detected position of the fixing belt 62 is obtained first. The steering control target value is changed to a value which is different from the obtained steering control target value. At this time, the steering control target value is changed so that the moving speed is increased as the position of the fixing belt 62 approaches the upper or lower limit position and so that the position of the fixing belt 62 falls within the moving range determined in step S32.

Steps S35 and S36 are similar to steps S13 and 14 in the first processing.

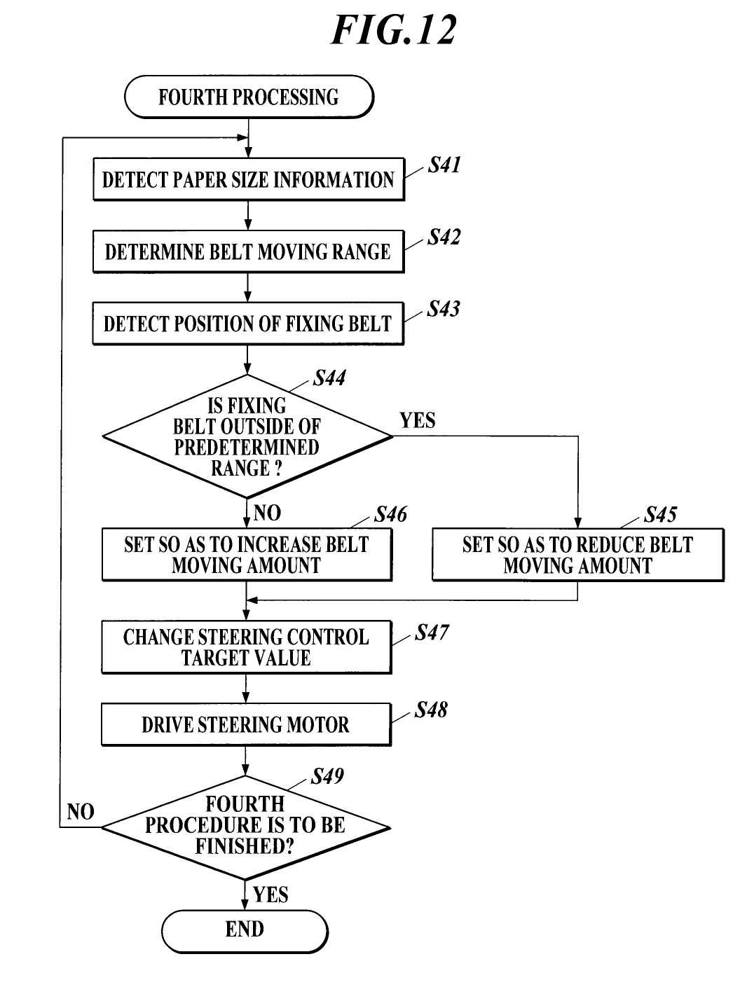

Next, the fourth processing will be described with reference to FIG. 12. In the fourth processing, when the position of the fixing belt 62 is within the limit range and outside the predetermined range, the steering control target value is changed so that the belt moving amount is set to a small value (moving amount C) and so that the position of the fixing belt 62 be within the moving range determined based on the paper size information.

It is assumed that the predetermined range is stored in the storage device in advance. Further, it is assumed that the moving amount B (see FIG. 8) and the moving amount C (see FIG. 8) are stored in the storage device as the moving amounts of the fixing belt 62, and that the moving ranges of the fixing belt 62 corresponding to paper sizes are stored in the storage device.

For example, detection of a flag indicating that an image forming operation is to be executed by the CPU 91 being a trigger, the fourth processing is executed by the CPU 91 cooperating with the fourth program which was read from the ROM 93 and expanded in the RAM 92.

Steps S41, S42 and S43 are similar to steps S31, S32 and S33 in the third processing. Steps S44, S45 and S46 are similar to steps S22, S23 and S24 in the second processing.

After steps S41 to S46, a steering control target value is set (step S47). In particular, the steering control target value at the detected position of the fixing belt 62 is obtained. Then, the steering control target value is changed to a value which is different from the obtained steering control target value. At this time, the steering control target value is changed so that the moving amount of the fixing belt 62 be the moving amount B or the moving amount C and so that the moving range does not exceed the moving range determined in step S42.

Steps S48 and S49 are similar to steps S13 and 14 in the first processing.

According to the embodiment, the steering control target value of the fixing belt 62 is changed in accordance with the position of the fixing belt 62 in the perpendicular direction, which is detected by the sensor 96, and the fixing belt 62 reciprocates based on the changed steering control target value. Therefore, it is possible to reduce the scars to be generated on the surface of the fixing belt 62 by the paper edges, and image failure can be reduced.

Further, because the fixing belt 62 is moved, a large driving unit is not required as in the structure in which the fixing roller is moved, and cost and size can be reduced.

Moreover, the steering control target value is changed so that the moving speed of the fixing belt 62 is increased as the position of the fixing belt 62 approaches the limit positions (upper or lower limit position: belt movement upper limit or belt movement lower limit). In such way, time during which the fixing belt 62 exists (or is located) at the upper or lower limit position can be made to be short, and it is possible to prevent the fixing belt 62 from coming off and also it is possible to reduce the scars to be generated at the upper and lower limit positions where the scars are relatively prone to be generated due to the reciprocating movement, and image failure can be reduced.

Further, when the position of the fixing belt 62 is within the limit range and outside the predetermined range, the steering control target value is changed so as to be the moving amount C. In such way, the fixing belt 62 does not reach the upper and lower limit positions, and it is possible to prevent the fixing belt 62 from coming off.

Furthermore, when the paper size is large, scars are prominently marked on the fixing belt 62 (fixing belt 62 is prone to be scared). At this time, the moving range of the fixing belt 62 is determined based on size information of the paper (paper size information) (for example, when the paper size is A3, the moving range of the fixing belt 62 is set to be larger than the moving range when the paper size is A4). Accordingly, the moving range of the fixing belt 62 can be changed in accordance with the paper size. In such way, the passing positions of the paper edges with respect to the fixing belt can be dispersed. Therefore, it is possible to reduce the scars to be generated on the surface of the fixing belt 62 by the paper edges, and image failure can be reduced.

Here, the description of the embodiment is one example of the fixing device and the image forming apparatus, and the present invention is not limited to the description.

For example, although the image forming apparatus 1 includes the control unit 90 in the embodiment, the invention is not limited to this structure. For example, the fixing unit 60 may include the control unit. In particular, the fixing unit 60 may include the configuration shown in FIG. 2. In such case, the each process shown in FIGS. 9 to 12 is to be executed by the control unit of the fixing device as the first control unit.

Further, in the configuration where the fixing nip H1 is formed, although the roller (heater roller 61) is located at the upper portion and the fixing belt 62 is located at the lower portion with respect to each other, the present invention is not limited to this. For example, the fixing belt may be disposed at the upper portion and the roller may be disposed at the lower portion, or both of the upper portion and the lower portion may be structured with the fixing belts.

Detailed structures and detailed operations of the fixing device and the image forming apparatus in the embodiment can be arbitrarily modified within the scope of the present invention.

According to one aspect of the preferred embodiment of the invention, there is provided a fixing device including a fixing belt to fix a toner image formed on a paper onto the paper, a driving unit to make the fixing belt reciprocate in a direction perpendicular to a feeding direction of the paper when fixing the toner image onto the paper and a detecting unit to detect a position of the fixing belt in the perpendicular direction, and a control target value of the fixing belt is changed in accordance with the position of the fixing belt in the perpendicular direction detected by the detecting unit, and the fixing belt is made to reciprocate by the driving unit based on the changed control target value.

Preferably, the fixing device further includes a first control unit to change the control target value of the fixing belt in accordance with the position of the fixing belt in the perpendicular direction detected by the detecting unit and to control the driving unit so as to make the fixing belt reciprocate by the driving unit based on the changed control target value.

Preferably, the first control unit obtains the control target value of the fixing belt at the position in the perpendicular direction detected by the detecting unit, and changes the control target value so that a moving speed of the fixing belt increases as the position of the fixing belt approaches limit positions which define limits of a range of a reciprocating movement of the fixing belt.

Preferably, when the fixing belt is located within a limit range which is determined by limit positions which define limits of a range of a reciprocating movement of the fixing belt and when the fixing belt is located outside a predetermined range which is narrower than the limit range by a predetermine distance, the first control unit changes the control target value so that the fixing belt does not reach the limit positions.

Preferably, the first control unit changes the control target value so that a moving speed of the fixing belt is reduced more when the fixing belt is located outside the predetermined range comparing to when the fixing belt is located within the predetermined range.

Preferably, the first control unit detects size information of the paper, and the first control unit determines a moving range which is allowed to be set within a limit range which is determined by limit positions which define limits of a range of a reciprocating movement of the fixing belt based on the detected size information of the paper and changes the control target value so that the fixing belt be located within the determined moving range.

According to one aspect of the preferred embodiment of the invention, there is provided an image forming apparatus including a fixing belt to fix a toner image formed on a paper onto the paper, a driving unit to make the fixing belt reciprocate in a direction perpendicular to a feeding direction of the paper when fixing the toner image onto the paper, a detecting unit to detect a position of the fixing belt in the perpendicular direction and a second control unit to change a control target value of the fixing belt in accordance with the position of the fixing belt in the perpendicular direction detected by the detecting unit and to control the driving unit so as to make the fixing belt reciprocate by the driving unit based on the changed control target value.

Preferably, the second control unit obtains the control target value of the fixing belt at the position in the perpendicular direction detected by the detecting unit, and the second control unit changes the control target value so that a moving speed of the fixing belt increases as the position of the fixing belt approaches limit positions which define limits of a range of a reciprocating movement of the fixing belt.

Preferably, when the fixing belt is located within a limit range which is determined by limit positions which define limits of a range of a reciprocating movement of the fixing belt and when the fixing belt is located outside a predetermined range which is narrower than the limit range by a predetermine distance, the second control unit changes the control target value so that the fixing belt does not reach the limit positions.

Preferably, the second control unit changes the control target value so that a moving speed of the fixing belt is reduced more when the fixing belt is located outside the predetermined range comparing to when the fixing belt is located within the predetermined range.

Preferably, the second control unit detects size information of the paper, and the second control unit determines a moving range which is allowed to be set within a limit range which is determined by limit positions which define limits of a range of a reciprocating movement of the fixing belt based on the detected size information of the paper and changes the control target value so that the fixing belt be located within the determined moving range.

The present U.S. patent application claims a priority right under Paris Convention based On Japanese Patent Application No. 2010-017539 filed in Japanese Patent Office on Jan. 29, 2010, and this Japanese Patent Application should be basis for future amendment of erroneous translation of this U.S. patent application.

What is claimed is:

1. A fixing device, comprising:
a fixing belt to fix a toner image formed on a paper onto the paper;
a driving unit to make the fixing belt reciprocate in a direction perpendicular to a feeding direction of the paper when fixing the toner image onto the paper; and
a detecting unit to detect a position of the fixing belt in the perpendicular direction, wherein
a control target value of the fixing belt is changed in accordance with the position of the fixing belt in the perpendicular direction detected by the detecting unit, and the fixing belt is made to reciprocate by the driving unit based on the changed control target value.

2. The fixing device of claim 1, further comprises a first control unit to change the control target value of the fixing belt in accordance with the position of the fixing belt in the perpendicular direction detected by the detecting unit and to control the driving unit so as to make the fixing belt reciprocate by the driving unit based on the changed control target value.

3. The fixing device of claim 2, wherein the first control unit obtains the control target value of the fixing belt at the position in the perpendicular direction detected by the detecting unit, and changes the control target value so that a moving speed of the fixing belt increases as the position of the fixing belt approaches limit positions which define limits of a range of a reciprocating movement of the fixing belt.

4. The fixing device of claim 2, wherein when the fixing belt is located within a limit range which is determined by limit positions which define limits of a range of a reciprocating movement of the fixing belt and when the fixing belt is located outside a predetermined range which is narrower than the limit range by a predetermine distance, the first control unit changes the control target value so that the fixing belt does not reach the limit positions.

5. The fixing device of claim 4, wherein the first control unit changes the control target value so that a moving speed of the fixing belt is reduced more when the fixing belt is located outside the predetermined range comparing to when the fixing belt is located within the predetermined range.

6. The fixing device of claim 2, wherein the first control unit detects size information of the paper, and the first control unit determines a moving range which is allowed to be set within a limit range which is determined by limit positions which define limits of a range of a reciprocating movement of the fixing belt based on the detected size information of the paper and changes the control target value so that the fixing belt be located within the determined moving range.

7. An image forming apparatus, comprising:
a fixing belt to fix a toner image formed on a paper onto the paper;
a driving unit to make the fixing belt reciprocate in a direction perpendicular to a feeding direction of the paper when fixing the toner image onto the paper;
a detecting unit to detect a position of the fixing belt in the perpendicular direction; and
a second control unit to change a control target value of the fixing belt in accordance with the position of the fixing belt in the perpendicular direction detected by the detecting unit and to control the driving unit so as to make the fixing belt reciprocate by the driving unit based on the changed control target value.

8. The image forming apparatus of claim 7, wherein the second control unit obtains the control target value of the fixing belt at the position in the perpendicular direction detected by the detecting unit, and the second control unit changes the control target value so that a moving speed of the fixing belt increases as the position of the fixing belt approaches limit positions which define limits of a range of a reciprocating movement of the fixing belt.

9. The image forming apparatus of claim 7, wherein when the fixing belt is located within a limit range which is determined by limit positions which define limits of a range of a reciprocating movement of the fixing belt and when the fixing belt is located outside a predetermined range which is narrower than the limit range by a predetermine distance, the second control unit changes the control target value so that the fixing belt does not reach the limit positions.

10. The image forming apparatus of claim 9, wherein the second control unit changes the control target value so that a moving speed of the fixing belt is reduced more when the fixing belt is located outside the predetermined range comparing to when the fixing belt is located within the predetermined range.

11. The image forming apparatus of claim 7, wherein the second control unit detects size information of the paper, and the second control unit determines a moving range which is allowed to be set within a limit range which is determined by limit positions which define limits of a range of a reciprocating movement of the fixing belt based on the detected size information of the paper and changes the control target value so that the fixing belt be located within the determined moving range.
